(19) United States
(12) Patent Application Publication
(10) Pub. No.: US 2009/0056743 A1
(43) Pub. Date: Mar. 5, 2009

(54) METHOD OF CLEANING PLASMA ENHANCED CHEMICAL VAPOR DEPOSITION CHAMBER

(76) Inventors: Soo Young Choi, Fremont, CA (US); John M. White, Hayward, CA (US); Beom Soo Park, San Jose, CA (US); Liwei Li, Sunnyvale, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/199,396

(22) Filed: Aug. 27, 2008

Related U.S. Application Data
(60) Provisional application No. 60/969,431, filed on Aug. 31, 2007.

(51) Int. Cl. B08B 6/00

(52) U.S. Cl. 134/1.1; 134/21

(57) ABSTRACT

A method and apparatus for cleaning a plasma enhanced chemical vapor deposition chamber is described. In one embodiment, the method includes providing a first cleaning gas to a processing region within the chamber; and then providing a second cleaning gas to the processing region. In another embodiment, the method includes providing a substantially pure fluorine gas to a processing chamber.

### CROSS-REFERENCE TO RELATED APPLICATIONS

This application claims benefit of U.S. Provisional Patent Application Ser. No. 60/969,431, filed Aug. 31, 2007 (Attorney Docket No. 12665L), which is incorporated herein by reference.

### BACKGROUND OF THE INVENTION

1. Field of the Invention

Embodiments of the present invention generally relate to a method of cleaning a deposition chamber. More particularly, to a method of cleaning a plasma enhanced chemical vapor deposition (PECVD) chamber used to deposit materials on large area substrates.

2. Description of the Related Art

In the fabrication of large area substrates for end uses such as flat panel displays, television or computer monitors, cell phone displays, solar cell arrays, and the like, various dielectric, semiconductive, and conductive layers are sequentially deposited on a surface of these large area substrates to produce electronic devices. The large area substrates may be made of glass, polymers, metal, or other suitable substrate material capable of having electronic devices formed thereon. To increase fabrication efficiency and/or lower production costs of the various end uses, the substrates are currently about 2,200 mm×about 2,600 mm, and larger.

The various layers formed on the large area substrates are generally deposited by plasma enhanced chemical vapor deposition (PECVD) chambers that are sized to receive the large area substrates. Thus, as substrate size continues to grow, so does the chamber size. The greater the chamber size, the greater the area within the chamber for unwanted deposits to form. For example, silicon may deposit on exposed areas within the chamber during device formation. If the silicon deposited on the exposed areas of the chamber is not effectively removed, the silicon may flake off and contaminate subsequent layers formed on the substrate, or the next substrate to be processed within the chamber may be contaminated by prior deposits on chamber components.

One challenge in chamber cleaning is the by-products that may be formed by a user's choice of cleaning media. For example, nitrogen, carbon, oxygen, and fluorine containing compounds, among other chemicals, in the cleaning gas may combine with, or be adsorbed on, chamber materials in a manner that may detrimentally affect subsequent processes or devices formed in the chamber. Precursor gases that are introduced to the chamber containing nitrogen, carbon, oxygen, and other chemicals, present another challenge that may have a detrimental effect on subsequent processes, or devices formed in the chamber.

Therefore, there is a need in the art for an effective cleaning method for large area substrate processing chambers in order to minimize or eliminate compounds formed within the chamber that may have a detrimental effect on subsequent processes or devices formed in the chamber.

### SUMMARY OF THE INVENTION

Embodiments described herein generally provide a method of processing a large area substrate in a processing region of a processing chamber and removing unwanted by-products from surfaces disposed in the processing region. In one embodiment, the method includes providing a large area substrate to a processing chamber, depositing one or more silicon layers on the substrate, removing the substrate from the processing chamber, providing a fluorine containing gas to the processing chamber, and providing an argon plasma purge to the processing chamber.

In another embodiment, a method of processing a plurality of large area substrates is described. The method includes providing a first large area substrate to an interior volume of a chamber, flowing a process gas to a processing region disposed in the interior volume, depositing one or more silicon containing layers on the first large area substrate, removing the first large area substrate from the interior volume of the chamber, providing a primary cleaning gas to the processing region, and purging the processing region with a secondary cleaning gas after the flowing the primary cleaning gas.

In another embodiment, a method of cleaning a solar cell processing chamber is described. The method includes providing a first cleaning gas to a processing region within the chamber, and then providing a second cleaning gas to the processing region, wherein the second gas is an argon plasma.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic cross sectional view of a processing apparatus.

FIG. 2 is a schematic view of a single junction solar cell.

FIG. 3 is a schematic view of a dual tandem solar cell.

FIG. 4 is a flow chart showing one embodiment of a processing method.

FIG. 5 is a flow chart showing one embodiment of a cleaning method.

FIG. 6 is a flow chart showing another embodiment of a cleaning method.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments described herein relate to processing large area substrates and removing unwanted deposits from an interior volume and components disposed in the interior volume of a plasma chamber, such as a plasma enhanced chemical vapor deposition (PECVD) chamber. The deposition and cleaning methods described herein are described in relation to thin film transistor (TFT) and thin film solar (TFS) fabrication on large area substrates, but may be adapted for use with chambers configured for other processes performed on large area substrates, such as organic light emitting diode (OLED) fabrication, among other electronic device formation processes. The large area substrates as described herein may be made of glass, a polymeric material or other material suitable for electronic device formation.

Embodiments of the invention will be illustratively described below in relation to a PECVD chamber available from AKT®, a subsidiary of Applied Materials, Inc., Santa Clara, Calif., although chambers made by other manufacturers or configured for other processes may benefit. It is to be understood that embodiments described herein may be equally applicable to any chamber that may energize a gas into a plasma using a radio frequency (RF) current, elevated temperature and/or low pressure, or other method used to form a plasma. Other chambers, such as physical vapor deposition (PVD) chambers, may also benefit from some of the embodiments.

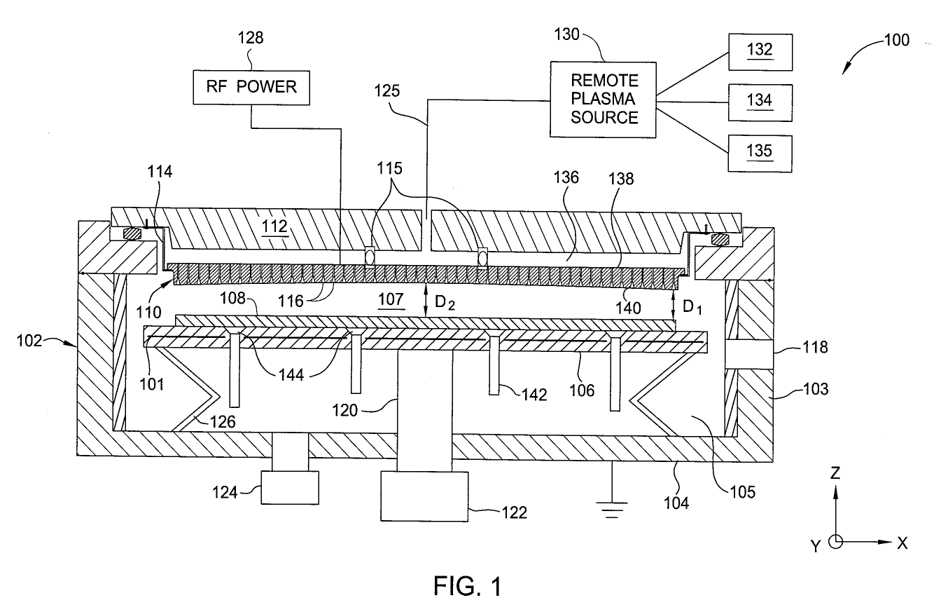

FIG. 1 is a schematic cross sectional view of a processing apparatus 100 according to one embodiment of the invention. The apparatus 100 comprises a PECVD chamber 102 that is adapted to receive a large area substrate 108 having a surface area of about 40,000 cm², or larger, such as about 50,000 cm² or larger, for example, about 55,000 cm² or about 90,000 cm², or larger. The chamber 102 includes an interior volume 105 bounded by a backing plate 112, sidewalls 103, and a bottom 104. In one embodiment, the interior volume 105 is between about 2,000 liters (L) and about 3,000 L, for example, about 2,700 L. The chamber 102 may be coupled to a vacuum pump 124 to provide negative pressure to the interior volume 105.

The chamber 102 may also include a substrate support or susceptor 106. The susceptor may include a heater 101 to provide thermal energy to the substrate 108 and/or the interior volume 105. The susceptor 106 may be grounded with flexible grounding straps 126 coupled with the bottom 104 of the chamber 102. The large area substrate 108 may be disposed on the susceptor 106 in an opposing relationship with a gas distribution plate or showerhead 110 within the chamber 102. The showerhead 110 may be supported within the chamber 102 by a flexible bracket 114 and/or one or more intermediate or center supports 115 that are coupled between the showerhead and the backing plate 112. The one or more center supports 115 are configured to provide support for a center area of the showerhead 110 during processing.

In one embodiment, the showerhead 110 includes a concave lower surface (in cross-section) to promote uniform deposition across the surface of the substrate 108. For example, the perimeter of the lower surface of the showerhead 110 may be planar while the center is concave or dished. In one embodiment, the showerhead 110 includes a perimeter that is spaced apart a first distance D¹ from the substrate 108 and/or an upper surface of the susceptor 108 in a processing position and the center is spaced apart a second distance D² from the substrate 108 and/or an upper surface of the susceptor 108 in a processing position. The second distance D² is greater than the first distance D¹.

The substrate 108 may be inserted into the chamber 102 through a port 118 formed in sidewall 103. The susceptor 106 may be coupled to a stem 120 and raised or lowered vertically by an actuator 122. The susceptor 106 includes a plurality of lift pins 142 movably disposed through the susceptor 106. The lift pins 142 include enlarged or flared ends 144 adapted to support the substrate 108 when the flared ends 144 are above the susceptor support surface. The lift pins may be actuated to move by lowering the susceptor 106 causing an end of the lift pins 142 opposite the flared end 144 to contact a bottom surface of the interior volume 105. Alternatively or additionally, the lift pins 142 may be actuated vertically by a lift plate (not shown) to raise and lower the lift pins 142. When the flared ends 144 are spaced apart from the upper surface of the susceptor 106, for example when the susceptor is in a lowered position (not shown), the substrate 108 may be transferred through port 118 by a robot blade (not shown) and disposed onto the lift pins 142. In this example, when the robot blade is removed, the susceptor 106 may be raised to place the substrate 108 on an upper surface of the susceptor 106 as shown.

Process gas may be provided to the showerhead 110 from a process gas source 132. Process gas source 132 includes silicon and/or hydrogen containing process gases. Examples include silanes (SiH₄, Si₂H₆, SiH₂Cl₂), silicon tetrafluoride (SiF₄), silicon tetrachloride (SiCl₄), hydrogen gas (H₂), and combinations thereof. The process gas may be provided to the processing region 107 through the remote plasma source 130 where the gas may be energized. Alternatively, the process gas may flow through the remote plasma 130 source without activation or energization from the remote plasma source 130. In one embodiment, process gases may be flowed through the remote plasma source 130 to the showerhead 110 by a conduit 125 and may be energized into a plasma in a processing region 107 between the susceptor 106 and showerhead 110 by a RF current applied from a RF power source 128. The gas is initially provided to a plenum 136 disposed between the backing plate 112 and the upstream side 138 of the showerhead 110. The gas may be substantially evenly distributed within the plenum 136 and then pass through a plurality of gas passages 116 in the showerhead 110 that extend between the upstream side 138 and a downstream side 140 of the showerhead 110. In one embodiment, the gas passages 116 may comprise hollow cathode cavities.

A primary cleaning gas source 134 and a secondary cleaning gas source 135 may be coupled to the showerhead 110 to provide cleaning gases to the processing region 107 and the interior volume 105 for a cleaning process. The cleaning gas sources 134, 135 may be coupled to a remote plasma source 130, such as a microwave generator or RF generator, to energize one or both of the gas from the cleaning gas sources 134, 135 into a plasma.

Although the processing region 107, i.e. a plasma formation region during a deposition process, is described as being between the showerhead 110 and substrate 106 and/or an upper surface of the susceptor 106, other portions of the interior volume 105, such as downstream side 140 of showerhead 110 and interior portions of sidewall 103, may be subjected to various chemical elements or compounds that adsorb or otherwise adhere thereon to produce undesirable residues that may subsequently flake or loosen and contaminate subsequent deposition. To minimize subsequent contamination during deposition processes on the same or subsequent substrates, a chamber dry cleaning process may be performed using the primary cleaning gas, the secondary cleaning gas, or combinations thereof.

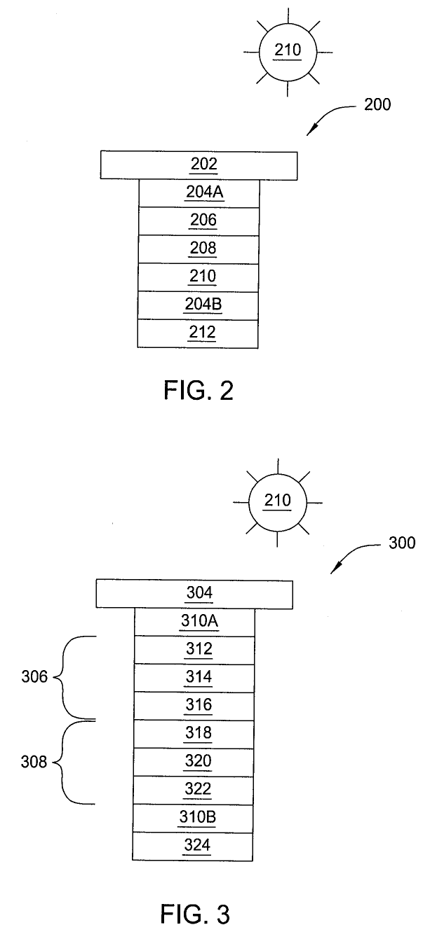

FIG. 2 is a schematic view of a single junction solar cell 200, at least a portion of which may be formed in the chamber 102. The solar cell 200 may be formed by depositing a first transparent conducting oxide (TCO) layer 204A, a p-doped semiconductor layer 206, an intrinsic semiconductor layer 208, an n-doped semiconductor layer 210, and a second TCO layer 204B over a substrate 202. A reflecting layer 212 comprising aluminum (Al) or silver (Ag) may be formed or disposed on the second TCO layer 204B. The solar cell 200, upon completion, is positioned so that the substrate 202 faces the sun 210. The semiconductor material for the solar cell 200 may comprise silicon. In one embodiment, the silicon comprises amorphous silicon. In another embodiment, the silicon comprises microcrystalline silicon. In yet another embodiment, the silicon comprises polysilicon.

FIG. 3 is a schematic view of a dual tandem solar cell 300, at least a portion of which may be formed in the chamber 102. The dual tandem solar cell 300, which may also be referred to as a tandem junction solar cell, may be formed by depositing a first cell 306 over a substrate 304 having a first TCO layer 310A located thereon and then a second cell 308 over the first cell 306. The first cell 306 may comprise a p-doped semiconductor layer 312, an intrinsic semiconductor layer 314, and an n-doped semiconductor layer 316. The second cell 308 may comprise a p-doped semiconductor layer 318, an intrinsic semiconductor layer 320, and an n-doped semiconductor layer 322. A second TCO layer 310B may be disposed on the second cell 308 and a reflecting layer 324 may be formed or disposed on the second TCO layer 310B. The solar cell 300, upon completion, is positioned so that the substrate 304 faces the sun 210.

The semiconductor material for the solar cell 300 may comprise silicon. In one embodiment, the silicon comprises amorphous silicon. In another embodiment, the silicon comprises microcrystalline silicon. In yet another embodiment, the silicon comprises polysilicon. The first cell 306 may comprise amorphous silicon as the intrinsic semiconductor layer 312 while the second cell 308 may comprise microcrystalline silicon as the intrinsic semiconductor layer 318. Thus, the solar cell 300 is a dual tandem solar cell 300 because it comprises two cells 306, 308 where each cell 306, 308 is different.

It is to be understood that while description relates to a dual tandem solar cell that may be formed in the chamber 102, the chamber 102 may also form a dual solar cell utilizing the same semiconductor material for both intrinsic semiconductor layers. Additionally, while a single junction solar cell and a dual tandem solar cell are described, other solar cell configurations may be formed in the chamber 102. For example, solar cells having greater than two cells are contemplated where the cells are either substantially identical or different.

A more detailed description of solar cells formed by the chamber 102 and other associated process and apparatus may be found in U.S. patent application Ser. No. 11/624,677, filed Jan. 18, 2007, and U.S. patent application Ser. No. 11/799,528, filed May 1, 2007, and U.S. patent application Ser. No. 12/174,408, filed Jul. 16, 2008. Each of the aforementioned patent applications are incorporated herein by reference.

To produce the solar cells 200 or 300, the various layers may be deposited within a common chamber or within separate chambers. In either scenario, contamination to subsequently processed substrates may be a concern. Thus, the chambers may be cleaned between each deposition. Alternatively, the chambers may be cleaned on an as needed basis.

To perform the chamber cleaning, a primary cleaning gas may be provided to the chamber 102 by a primary gas source 134, which includes a primary cleaning gas. In one embodiment, the primary cleaning gas is fluorine (F₂) that is substantially pure. In another embodiment, suitable primary cleaning gases include fluorine containing gases, such as nitrogen trifluoride (NF₃), sulfur hexafluoride (SF₆), fluorine gas (F₂), and carbon/fluorine containing gases, such as fluorocarbons, for example octofluorotetrahydrofuran (C₄F₈O), carbonyl fluoride (COF₂), hexafluoroethane (C₂F₆), tetrafluoromethane (CF₄), perfluoropropane (C₃F₈), and combinations thereof. Although carbon and oxygen containing gases may be used, the gases are not favorable due to possible carbon and/or oxygen contamination.

The primary cleaning gas may pass through the remote plasma source 130 where the primary cleaning gas may be energized into a plasma prior to entering the chamber 102 to perform a primary cleaning process. The activated primary cleaning gas flows along the conductance path through the showerhead 110 and into the processing region 107 to clean interior surfaces of the interior volume 105 and other surfaces disposed in the interior volume 105. Alternatively, the primary cleaning gas is provided directly to the showerhead 110 where the primary cleaning gas may be activated by RF power source 128 and/or thermal energy to clean interior surfaces of the interior volume 105 and other surfaces disposed in the interior volume 105. In another alternative, the primary cleaning gas may be flowed to the showerhead 110 in an unactivated state and flowed along the path of conductance without energization to clean interior surfaces of the interior volume 105 and other surfaces disposed in the interior volume 105.

A secondary cleaning gas may be provided by secondary gas source 135. Suitable secondary cleaning gases include noble or inert gases. In one embodiment, the secondary cleaning gas is argon (Ar). The secondary cleaning gas may pass through a remote plasma source 130 where the secondary cleaning gas may be energized into a plasma prior to entering the chamber 102 to perform a secondary cleaning process. The activated secondary cleaning gas flows along the conductance path through the showerhead 110 and into the processing region 107 to clean interior surfaces of the interior volume 105 and other surfaces disposed in the interior volume 105. Alternatively, the secondary cleaning gas is provided directly to the showerhead 110 where the secondary cleaning gas may be activated by RF power source 128 to form a plasma at the processing region 107 to clean interior surfaces of the interior volume 105 and other surfaces disposed in the interior volume 105. In another alternative, the secondary cleaning gas may be flowed to the showerhead 110 in an unactivated state and flowed along the path of conductance without energization to clean interior surfaces of the interior volume 105 and other surfaces disposed in the interior volume 105.

In the fabrication of the solar cells 200 and 300, nitrogen and fluorine contamination within the interior volume 105 is detrimental to the deposition process and/or solar cell performance. Nitrogen may be introduced to the interior volume 105 in many ways. One is by using nitrogen containing gases for processes within the chamber 102, and another is by adsorption of atmospheric nitrogen during servicing of the chamber or when the interior volume is otherwise exposed to the atmosphere. The nitrogen may form undesirable deposits that may negatively affect solar cell performance. Table 1 shows test results of tandem junction solar cell film stacks fabricated within the chamber 102 with and without nitrogen contamination in the interior volume 105. The tandem junction solar cells included a p-doped semiconductor layer comprising microcrystalline silicon. In table 1, CE refers to conversion efficiency, J_{SC} refers to short circuit density, V_{OC} refers to open circuit voltage, and FF refers to fill factor. Nitrogen counts (N counts) are measured by secondary ion mass spectroscopy (SIMS) on the solar cell film stack.

TABLE 1

| | | | | | Resistivity | SIMS |
|---|---|---|---|---|---|---|
| N | CE | J_{sc} | V_{oc} | FF | Ohm | N counts |
| contamination | % | mA/cm² | V | % | (Ω) · cm | (atoms/cm³) |
| Yes | 6.2 | 8.2 | 1.300 | 58.0 | 1836 | 7.34E+18 |
| No | 10.7 | 10.6 | 1.390 | 73.1 | 0.56 | 1.05E+17 |

In the case of fluorine contamination, reactive fluorine radicals may be adsorbed onto a surface of conductance during a cleaning process. Fluorine from the remote plasma source 130 may form compounds with the material comprising the showerhead 110 or other surfaces in the interior volume 105 of chamber 102. As many chamber components comprise aluminum, aluminum fluoride may form on these surfaces, which may cause particle contamination to substrates processed in the chamber 102.

To abate nitrogen and/or fluorine from the interior volume 105, argon (Ar) may be flowed to the chamber 102. Argon may be provided from the secondary cleaning gas source 135 and activated either in-situ, i.e. in the interior volume 105 by RF power, or a plasma may be provided to the chamber 102 by providing argon to the remote plasma source 130 and flowing argon plasma to the chamber 102. In this manner, argon radicals are flowed through the conductance path and/or in the interior volume 105 to remove surface adsorbed nitrogen.

To reduce nitrogen contamination in the chamber, primary cleaning gases that are nitrogen-free may be used successfully to perform a chamber cleaning process. In one embodiment, fluorine gas (F₂) may be provided by the primary cleaning gas source 134 to the chamber 102. The fluorine gas as described herein is void of any nitrogen or other element, and may be substantially pure.

In one application, fluorine gas is provided to the chamber and activated into a plasma to perform a cleaning process. The activation of the fluorine gas may be in-situ, wherein the fluorine gas is flowed directly to the chamber 102 and activated in the processing region 107 by RF power source 128, thermal energy, or a combination thereof. In another application, fluorine plasma is generated ex-situ by flowing fluorine gas to the remote plasma source 130, wherein the fluorine gas is activated therein to produce F radicals that are flowed to the chamber 102. In another application, fluorine gas is provided to the chamber 102 without activation and a cleaning process may be performed by molecular fluorine facilitated by thermal energy within the chamber 102.

Tests to compare solar cell performance with and without a post-clean argon purge to abate nitrogen and/or fluorine from the chamber 102 were conducted. Table 2 shows test results of single junction solar cells fabricated within the chamber 102 with and without a post-clean argon purge.

TABLE 2

| | | | | | SIMS | |
|---|---|---|---|---|---|---|
| | CE | J_{sc} | V_{oc} | FF | N counts | F counts |
| | % | mA/cm² | V | % | (atoms/cm³) | (atoms/cm³) |
| No Ar purge | 6.26 | 13.27 | 0.904 | 52.5 | 1.50E+20 | 3.10E+19 |
| Post Ar | 9.31 | 13.51 | 0.910 | 73.9 | 2.00E+17 | 5.00E+16 |
| purge | | | | | | |

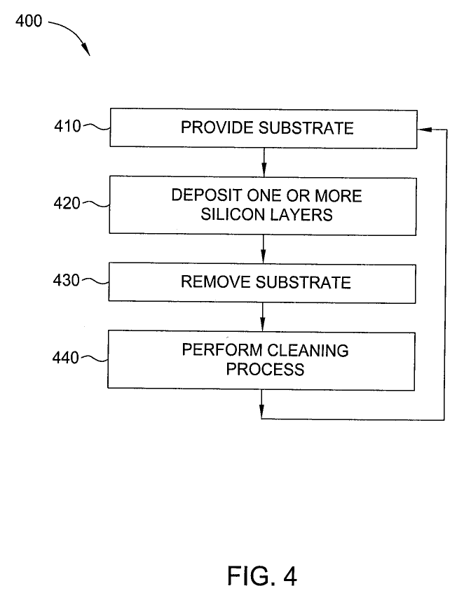

FIG. 4 is a flow chart showing one embodiment of a processing method 400 that may be used to process a large area substrate. At 410, a large area substrate is provided to the chamber 102. At 420, a deposition process may be performed to deposit one or more silicon layers on the substrate. The silicon layer may be amorphous silicon, microcrystalline silicon, or polysilicon. At 430, the substrate having the one or more silicon layers formed thereon is transferred from the chamber 102. At 440, a chamber cleaning process is performed by providing a cleaning gas to the chamber 102. A number of substrates may be sequentially provided to the chamber 102 for a deposition process followed by the cleaning process at 440 between processing of each substrate, or at user defined intervals.

The chamber cleaning at 440 includes providing a primary cleaning gas, a secondary cleaning gas, or a combination of the primary cleaning gas and the secondary cleaning gas. In one embodiment, a primary cleaning gas comprising nitrogen is provided to the chamber 102. In another embodiment, a primary cleaning gas comprising a fluorine containing gas is provided to the chamber. In another embodiment, a primary cleaning gas consisting of a substantially pure fluorine gas is provided to the chamber. In any of these embodiments, the primary cleaning gas may be activated to form a plasma to clean unwanted deposits from surfaces and/or conductance paths within the chamber 102.

Optionally or additionally, step 440 includes providing a secondary cleaning gas, such as a noble gas, for example argon. The argon may be flowed from secondary cleaning gas source 135 to the remote plasma source 130, and a plasma of argon gas may be flowed to the showerhead 110 and processing region 107. Thus, nitrogen and/or fluorine compounds that may have formed on surfaces in the interior volume 105 may be removed by vacuum pump 124 or other exhaust system.

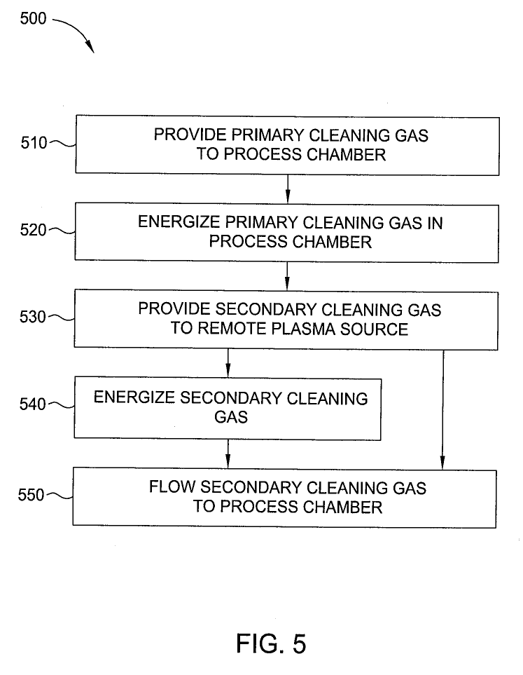

FIG. 5 is a flowchart showing one embodiment of a cleaning method 500. At 510, a primary cleaning gas is provided to the chamber 102 from the primary cleaning gas source 134 without energization. In one embodiment, the primary cleaning gas flows from the primary gas source 134 through the remote plasma source 130 and the gas is not energized by the remote plasma source 130. In one embodiment, a primary cleaning gas comprising fluorine and nitrogen may be used. In another embodiment, the primary cleaning gas may be nitrogen-free, consisting of a substantially pure fluorine gas. In this embodiment, a plasma of the primary gas is formed in the processing region using RF power and/or is activated by thermal energy as shown at 520. The activated primary gas flows along the conductance path in the interior volume 105 of the chamber 102 cleaning interior surfaces.

At 530, a secondary cleaning gas from the secondary cleaning gas source 135 is provided to the remote plasma source 130. In one embodiment, the secondary cleaning gas is argon. In one embodiment, the secondary cleaning gas may be activated in the remote plasma source 130 to form a plasma as shown at 540. In this embodiment, the secondary cleaning gas radicals are flowed to the process chamber 102 as shown at 550. The activated secondary gas flows along the conductance path in the interior volume 105 of the chamber 102 cleaning interior surfaces. In an alternative, the secondary cleaning gas may be flowed directly from the remote plasma source 130 to the processing chamber without energization as shown at 550. The secondary gas in elemental or molecular form flows along the conductance path in the interior volume 105 of the chamber 102 cleaning interior surfaces.

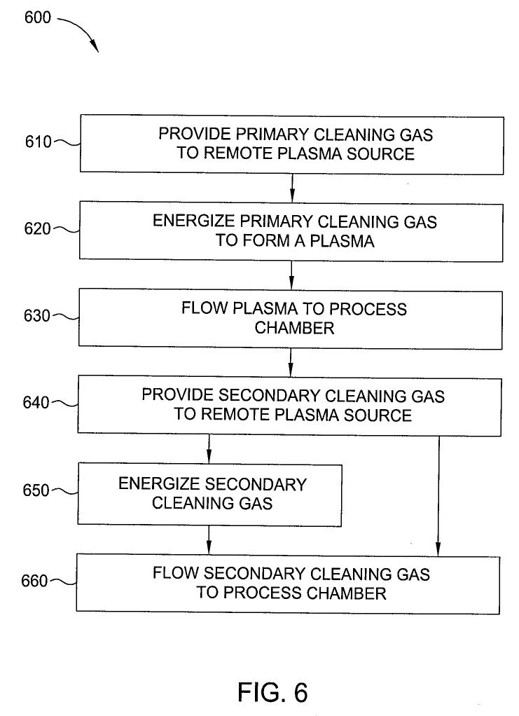

FIG. 6 is a flowchart showing one embodiment of a cleaning method 600. At 610, a primary cleaning gas is provided from the primary gas source 134 to the remote plasma source 130. In one embodiment, a primary cleaning gas comprising fluorine and nitrogen may be used. In another embodiment, the primary cleaning gas may be nitrogen-free, consisting of a substantially pure fluorine gas. At 620, the primary cleaning gas is activated in the remote plasma source 130. At 630, the activated primary cleaning gas is flowed to the chamber 102. The activated primary gas flows along a conductance path cleaning interior surfaces. Conductance path as used herein includes interior surfaces of the conduit 125 coupled to the remote plasma source 130 (FIG. 1) as well as surfaces within the interior volume 105.

At 640, a secondary cleaning gas from the secondary cleaning gas source 135 is provided to the remote plasma source 130. In one embodiment, the secondary cleaning gas is argon. In one embodiment, the secondary cleaning gas may be activated in the remote plasma source 130 to form a plasma as shown at 650. In this embodiment, the secondary cleaning gas radicals are flowed to the process chamber 102 as shown at 660. The activated secondary gas flows along the conductance path in the interior volume 105 of the chamber 102 cleaning interior surfaces. In an alternative, the secondary cleaning gas may be flowed directly from the remote plasma source 130 to the processing chamber without energization as shown at 660. The secondary gas in elemental or molecular form flows along the conductance path in the interior volume 105 of the chamber 102 cleaning interior surfaces.

While the foregoing is directed to embodiments of the present invention, other and further embodiments of the invention may be devised without departing from the basic scope thereof, and the scope thereof is determined by the claims that follow.

1. A method of processing a large area substrate, comprising:
providing a large area substrate to a processing chamber;
depositing one or more silicon layers on the substrate to form a portion of a solar cell;
removing the substrate from the processing chamber;
flowing a fluorine containing gas to the processing chamber from a remote chamber; and
providing an argon purge to the processing chamber.

2. The method of claim 1, wherein the fluorine containing gas is selected from the group consisting of nitrogen trifluoride, sulfur hexafluoride, and diatomic fluorine.

3. The method of claim 1, further comprising:
activating the fluorine containing gas in the processing chamber to form a plasma.

4. The method of claim 1, further comprising:
activating the fluorine containing gas in the remote chamber to form a plasma; and
flowing the plasma to the processing chamber.

5. The method of claim 1, wherein the fluorine containing gas comprises a plasma.

6. The method of claim 5, wherein the fluorine containing gas is nitrogen-free and substantially pure.

7. The method of claim 1, wherein the fluorine containing gas comprises molecular fluorine.

8. The method of claim 7, wherein the fluorine containing gas is nitrogen-free and substantially pure.

9. The method of claim 1, wherein the one or more silicon layers include amorphous silicon, microcrystalline silicon, polysilicon, or combinations thereof.

10. The method of claim 1, wherein the argon purge is an argon plasma.

11. The method of claim 1, wherein the solar cell comprises a single junction solar cell.

12. The method of claim 1, wherein the solar cell comprises a dual tandem solar cell.

13. A method of processing a plurality of large area substrates, comprising:
a) providing a first large area substrate to an interior volume of a chamber;
b) flowing a process gas to a processing region disposed in the interior volume;
c) depositing one or more silicon containing layers on the first large area substrate;
d) removing the first large area substrate from the interior volume of the chamber;
e) providing a primary cleaning gas to the processing region; and
f) purging the processing region with a secondary cleaning gas after the flowing the primary cleaning gas.

14. The method of claim 13, further comprising:
g) providing a second large area substrate to the interior volume of the chamber; and
h) repeating b-f.

15. The method of claim 13, wherein the one or more silicon layers form a portion of a thin film transistor.

16. The method of claim 13, wherein the one or more silicon layers form a portion of a solar cell.

17. The method of claim 13, wherein the primary cleaning gas is a fluorine containing gas.

18. The method of claim 13, wherein the primary cleaning gas is a nitrogen containing gas.

19. The method of claim 13, wherein the secondary cleaning gas is argon.

20. The method of claim 13, wherein the primary cleaning gas is a plasma consisting essentially of fluorine.

21. The method of claim 13, wherein the primary cleaning gas is a plasma of a nitrogen containing gas.

22. The method of claim 13, wherein the secondary cleaning gas is a plasma consisting essentially of argon.

23. A method for processing a substrate to form a plurality of solar cells, comprising:
a) providing a large area substrate to a processing chamber;
b) depositing one or more silicon layers on the substrate to form the plurality of a solar cells, each of the plurality of solar cells comprising a single junction solar cell or a dual tandem solar cell;
c) removing the substrate from the processing chamber; and
d) flowing a plasma consisting essentially of fluorine to the processing chamber from a remote chamber.

24. The method of claim 23, wherein the fluorine containing gas is selected from the group consisting of nitrogen trifluoride, sulfur hexafluoride, and diatomic fluorine.

25. The method of claim 23, further comprising:
e) providing an argon plasma to the processing chamber from the remote chamber after d.
